(19) United States
(12) Patent Application Publication
(10) Pub. No.: US 2025/0317051 A1
(43) Pub. Date: Oct. 9, 2025

(54) COMMUTATION ASSISTANCE BY CONTROLLING THE SHAPE OF THE CURRENT WAVE IN A BIDIRECTIONAL TOTEM POLE CONVERTER

(71) Applicant: STMicroelectronics International N.V., Geneva (CH)

(72) Inventors: Yannick HAGUE, Mettray (FR); Romain LAUNOIS, Tours (FR); Guillaume THIENNOT, Pernay (FR)

(73) Assignee: STMicroelectronics International N.V., Geneva (CH)

(21) Appl. No.: 19/246,311

(22) Filed: Jun. 23, 2025

Related U.S. Application Data
(62) Division of application No. 18/203,299, filed on May 30, 2023, now Pat. No. 12,362,662.

(51) Int. Cl. H02M 1/42; H02M 1/00; H02M 1/08

(52) U.S. Cl. CPC H02M 1/4233; H02M 1/0085; H02M 1/081

(57) ABSTRACT

A power-factor correction system, includes a high-frequency branch with a first-transistor connected between an IO-node and high-frequency tap, and a second-transistor connected between the high-frequency tap and reference-node, and a low-frequency branch with a first-thyristor connected between the IO-node and low-frequency tap, and a second-thyristor connected between the low-frequency tap and reference-node. An inductor is connected between a first-node and the high-frequency tap. A first capacitor is connected between the first-node and the low-frequency tap. The first-node and the low-frequency tap are coupled to input-terminals. A control circuit generates first and second gate-drive signals for the first and second transistors to accelerate a decrease of an AC current waveform at the input-terminals after a peak of a half-cycle of the AC current waveform so the AC current waveform falls below a holding current of the second thyristor prior to a zero crossing of an AC voltage waveform at the input-terminals.

### CROSS REFERENCE TO RELATED APPLICATIONS

This application is a division of U.S. patent application Ser. No. 18/203,299, filed May 30, 2023, the contents of which are incorporated by reference in their entirety to the maximum extent allowable under the law.

### TECHNICAL FIELD

This disclosure relates generally to power electronics and, more specifically, to bidirectional totem pole power factor correction (PFC) converters with commutation assistance provided via control of the shape of the input voltage/current wave.

### BACKGROUND

Power factor correction (PFC) is technique utilized in power electronics systems to minimize the phase difference between voltage and current waveforms, in turn reducing losses in power distribution networks and enhancing the overall efficiency of the system.

Bidirectional totem pole PFC converters are specialized devices that perform power factor correction while also providing bidirectional power flow capability. In addition to their function of power factor correction, bidirectional totem pole PFC converters can also operate in inverter mode in which the bidirectional totem pole PFC converter processes power from a DC source and generates an AC output voltage waveform suitable for supplying AC loads or injecting power into the grid.

A conventional bidirectional totem pole PFC 10 is shown in FIG. 1. The totem pole PFC 10 includes an inductor L1 connected between a node N1 and the positive terminal of an AC source 13. The negative terminal of the AC source 13 is connected to a node N2. A filtering capacitor C is connected in parallel with the AC source 13. An n-channel transistor MN1 has its drain connected to node HVDC, its source connected to node N1, and its gate driven by a gate drive signal D1. Another n-channel transistor MN2 has its drain connected to node N1, its source connected to ground, and its gate driven by a gate drive signal D2. The n-channel transistors MN1 and MN2 form a high frequency branch 11.

A first thyristor Th1 has its cathode connected to node HVDC, its anode connected to node N2, and its cathode gate connected to a gate drive signal D3. A second thyristor Th2 has its cathode connected to node N2, its anode connected to ground, and its cathode gate driven by a gate drive signal D4. A third thyristor Th3 has its anode connected to node HVDC, its cathode connected to node N3, and its cathode gate driven by a gate drive signal D5. A fourth thyristor Th4 has its anode connected to node N3, its cathode connected to ground, and its cathode gate driven by a gate drive signal D6. Node N2 is connected to node N3. The thyristors Th1, Th2, Th3, and Th4 form a low frequency branch 12. Although the thyristors are illustrated as cathode-gated devices, it will be understood that anode-gated thyristors could instead be used.

A capacitor C1 is connected between node HVDC and ground, providing energy storage and filtering for the converter. The transistors MN1 and MN2 of the high-frequency branch are responsible for shaping the current waveform to achieve the desired power factor and maintain control loop stability. The thyristors Th1, Th2, Th3, and Th4 of the low-frequency branch primarily handle the majority of the power transfer and reduce conduction losses.

A problem arises with the conventional bidirectional totem pole PFC 10 during the zero-crossing of the AC waveform. At the zero-crossing point, it is desired for the thyristor Th3/Th4 to be turned off, allowing the AC waveform to transition smoothly between its half-cycles. However, for a thyristor to turn off, the current through the thyristor must fall below its holding current, typically at or near zero. In the case of positive polarity, if the current through thyristor Th4 does not fall below the holding current before the voltage waveform switches polarity, thyristor Th4 remains in the conducting state, leading to an undesired current flow.

This unintended current flow occurs when thyristor Th4 stays on during the zero-crossing of the AC waveform. The current path starts from the AC source 13, continues to node N3, flows through thyristor Th4, returns through the ground rail, and moves through the body diode of transistor MN2 and inductor L1 before reaching the AC source 13 again. This unintended current flow can potentially cause damage to transistor MN2 and other components, affecting the overall efficiency, reliability, and performance of the bidirectional totem pole PFC converter 10.

Graphs of the inductor current IL and AC waveform voltage VC across the filtering capacitor C during operation without issues are shown in FIGS. 2-3. In both cases, it can be observed that the inductor current IL (representative of the current through thyristor Th4) falls to zero prior to the zero-crossing of the AC waveform VC. As such, observe that the inductor current IL remains at zero during the negative portion of the AC voltage waveform.

However, in FIG. 4, the inductor current IL does not fall to zero prior to the zero-crossing of the AC waveform VC. As a result, the current flow situation described above occurs, and the inductor current IL rises during the negative portion of the AC voltage waveform. Since this current is flowing through the body diode of transistor MN2 as described earlier, damage may occur.

One known method to address this problem is to introduce or adjust the dead time in the control of the transistors MN1 and MN2 before the zero-crossing of the AC waveform. Dead time refers to the intentional delay between turning off of the transistors MN1 and MN2 and the reversal of the AC waveform polarity. By ceasing the switching of the transistors MN1 and MN2, the dead time allows the current through thyristor Th4 to fall below its holding current, providing for a proper zero-crossing of the current before the reversal of the AC waveform polarity.

A drawback of using dead time to address the zero-crossing issue is its impact on the Total Harmonic Distortion (THD), which is a measure of the distortion of the output voltage or current waveform compared to an ideal waveform. The longer the dead time, the higher the THD, as the output waveform deviates more significantly from the ideal sinusoidal shape during the non-conducting period. This increased THD can lead to diminished power quality, reduced system efficiency, and potential interference with other devices or systems connected to the same power grid and is therefore undesirable.

Given this, a need remains for an enhanced approach to commutation assistance that improves the performance of bidirectional totem pole PFC systems, providing a smooth transition during the zero-crossing of the AC waveform without the drawbacks associated with the dead time approach described above.

### SUMMARY

A bidirectional power factor correction system includes a high-frequency branch that has a first transistor connected between an IO node and a high-frequency tap, and a second transistor connected between the high-frequency tap and a reference node. The system also includes a low-frequency branch that has a first thyristor connected between the IO node and a low-frequency tap, and a second thyristor connected between the low-frequency tap and the reference node. An inductor is connected between a first node and the high-frequency tap. A first capacitor is connected between the first node and the low-frequency tap, where the first node and the low-frequency tap are coupled to input terminals. A control circuit is configured to generate first and second gate drive signals for the first and second transistors so as to accelerate a decrease of an AC current waveform at the input terminals after a peak of a half-cycle of the AC current waveform so that the AC current waveform falls below a holding current of the second thyristor prior to a zero crossing of an AC voltage waveform at the input terminals.

The control circuit may be configured to accelerate the decrease of the AC current waveform after the peak of the half-cycle of the AC current waveform by comparing a digital reference current to a digital feedback current and generating the first and second gate drive signals based thereupon so that the digital feedback current matches the digital reference current, where the digital feedback current is based upon the AC current waveform.

The control circuit may include a controller configured to generate the digital reference current based upon stored data, a current comparator configured to generate a comparison signal based upon comparing the digital reference current to the digital feedback current, a fast proportional-integral controller configured to generate a PWM control signal based upon the comparison signal, a pulse width modulation (PWM) circuit configured to generate gate pre-drive signals based upon the PWM control signal, a gate driving circuit configured to generate the first and second gate drive signals based upon the gate pre-drive signals, a scaling circuit configured to scale the AC current waveform to produce a scaled waveform, and an analog to digital converter configured to digitize the scaled waveform to produce the digital feedback current.

The stored data may include multiple tables, including a first table for low voltage applications and a second table for high voltage applications.

The controller may be configured to generate the digital reference current based on mathematical models that calculate values λ and μ from initial circuit conditions.

The control circuit may be further configured to generate third and fourth gate drive signals for the first and second thyristors.

The control circuit may be configured to determine the accelerated decrease based on a safety margin ΔT representing a time between when the AC current waveform falls below the holding current and when the AC voltage waveform reaches zero crossing.

The safety margin ΔT may be selected to minimize total harmonic distortion while providing sufficient buffer time for reliable thyristor turn-off.

The system may further include common mode inductors connected in series between the first node and the high-frequency tap, and filtering capacitors connected between respective nodes of the common mode inductors.

The system may further include bypass diodes connected in parallel with the high-frequency branch and low-frequency branch respectively.

The bidirectional power factor correction system may be operable in both power factor correction mode and inverter mode.

The first and second transistors may include n-channel MOSFETs and the first and second thyristors may include cathode-gated thyristors.

The control circuit may be configured to cease switching of the first and second transistors during a dead time period to allow current through the second thyristor to fall below the holding current.

A bidirectional power factor correction system includes a high-frequency branch that has a first transistor connected between an IO node and a high-frequency tap, and a second transistor connected between the high-frequency tap and a reference node. The system also includes a low-frequency branch that has a first thyristor connected between the IO node and a low-frequency tap, and a second thyristor connected between the low-frequency tap and the reference node. An inductor is connected between a first node and the high-frequency tap. A first capacitor is connected between the first node and the low-frequency tap, where the first node and the low-frequency tap are coupled to input terminals. A control circuit is configured to generate first and second gate drive signals for the first and second transistors of the high-frequency branch so as to modify an AC signal at the input terminals such that an AC current of the AC signal falls below a holding current of the second thyristor prior to a zero crossing of an AC voltage of the AC signal at the input terminals.

The control circuit may modify the AC signal by generating the first and second gate drive signals so as to change the AC signal at the input terminals after a peak of a half-cycle thereof.

The control circuit may modify the AC signal based upon a comparison between a digital reference and a digital feedback based upon the AC signal.

The digital reference may be a digital reference current and the digital feedback may be a digital feedback current.

The control circuit may be configured to create a plateau in the AC voltage for a given period of time after a peak of a half-cycle of the AC voltage.

The control circuit may create the plateau by generating the first and second gate drive signals to cause the first and second transistors to apply an assist voltage to the AC voltage during the given period of time.

A method of controlling commutation in a bidirectional power factor correction system having a high-frequency branch with first and second transistors and a low-frequency branch with first and second thyristors includes detecting a peak of a half-cycle of an AC signal at input terminals. After detecting the peak, the method includes modifying a waveform characteristic of the AC signal by controlling switching of the first and second transistors such that an AC current of the AC signal falls below a holding current of the second thyristor prior to a zero crossing of an AC voltage of the AC signal, thereby preventing unintended current flow through the second thyristor during the zero crossing.

Modifying the waveform characteristic may include accelerating a decrease of the AC current after the peak by generating gate drive signals for the first and second transistors based on a comparison between a digital reference current and a digital feedback current derived from the AC current.

The digital reference current may be generated from stored data that includes multiple lookup tables, each table corresponding to different operating conditions of the bidirectional power factor correction system.

Modifying the waveform characteristic may include creating a plateau in the AC voltage for a predetermined time period after the peak by applying an assist voltage to the AC voltage through controlled switching of the first and second transistors.

The assist voltage may be calculated based on circuit parameters including inductance, capacitance, and a time duration for maintaining the plateau, such that the AC voltage does not zero cross until the AC current falls below the holding current.

The method may further include determining a safety margin ΔT representing a desired time between when the AC current falls below the holding current and when the AC voltage reaches zero crossing, and controlling the modification of the waveform characteristic based on the determined safety margin to minimize total harmonic distortion while ensuring reliable thyristor turn-off.

### BRIEF DESCRIPTION OF THE DRAWINGS

FIG. 1 is a schematic diagram of a conventional bidirectional totem pole PFC system.

FIG. 2 is a graph illustrating the AC current waveform in the conventional bidirectional totem pole PFC system of FIG. 1 when operating at a first current level.

FIG. 3 is a graph illustrating the AC current waveform in the conventional bidirectional totem pole PFC system of FIG. 1 when operating at a second current level.

FIG. 4 is a graph illustrating the AC current waveform in the conventional bidirectional totem pole PFC system of FIG. 1 when operating at a third current level.

FIG. 5 is a schematic diagram of a bidirectional totem pole PFC system disclosed herein.

FIG. 6 is a block diagram of a first control loop for the system of FIG. 5 disclosed herein.

FIG. 7 is a circuit model of the system of FIG. 5 in a condition in which transistors are turned off before the reversal of the AC waveform polarity.

FIG. 8 is a series of graphs showing the relationship between the safety margin of FIG. 5 in operation and the holding current and dead time.

FIG. 9 is a series of graphs showing a comparison between the potential generated reference currents in FIG. 5 and a prior art reference current.

FIG. 10 is a graph showing the effect of the first control loop of FIG. 6 on the AC current waveform.

FIG. 11 is a block diagram of a second control loop for the system of FIG. 5 disclosed herein.

FIG. 12 is a circuit model of the system of FIG. 5 at the peak of the positive half wave of the AC voltage waveform.

FIG. 13 is a graph showing the effect of the application of the assist voltage to the AC voltage waveform of FIG. 5.

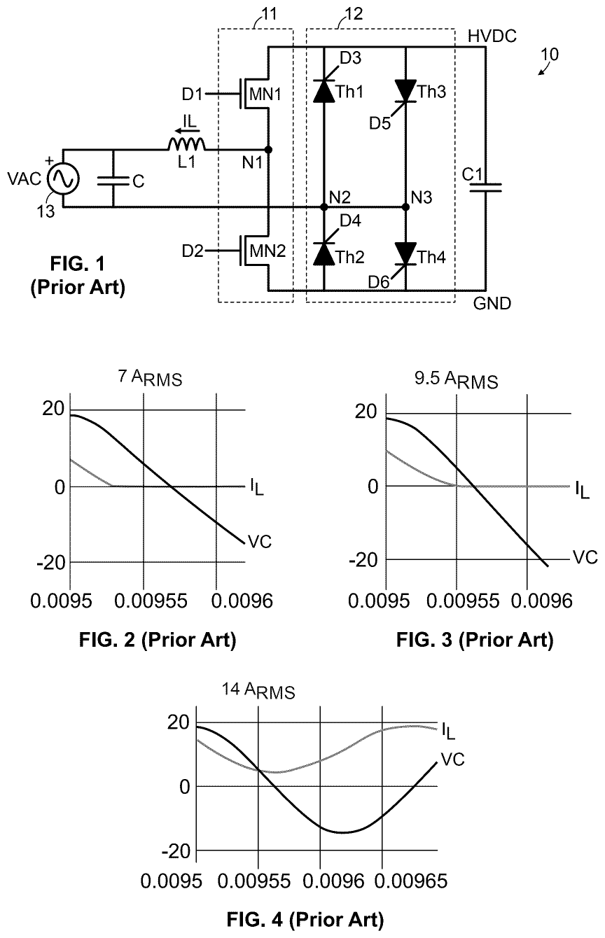

### DETAILED DESCRIPTION

The following disclosure enables a person skilled in the art to make and use the subject matter described herein. The general principles outlined in this disclosure can be applied to embodiments and applications other than those detailed above without departing from the spirit and scope of this disclosure. It is not intended to limit this disclosure to the embodiments shown, but to accord it the widest scope consistent with the principles and features disclosed or suggested herein.

Note that in the following description, any resistor or resistance mentioned is a discrete device, unless stated otherwise, and is not simply an electrical lead between two points. Therefore, any resistor or resistance connected between two points has a higher resistance than a lead between those two points, and such resistor or resistance cannot be interpreted as a lead. Similarly, any capacitor or capacitance mentioned is a discrete device, unless stated otherwise, and is not a parasitic element, unless stated otherwise. Additionally, any inductor or inductance mentioned is a discrete device, unless stated otherwise, and is not a parasitic element, unless stated otherwise.

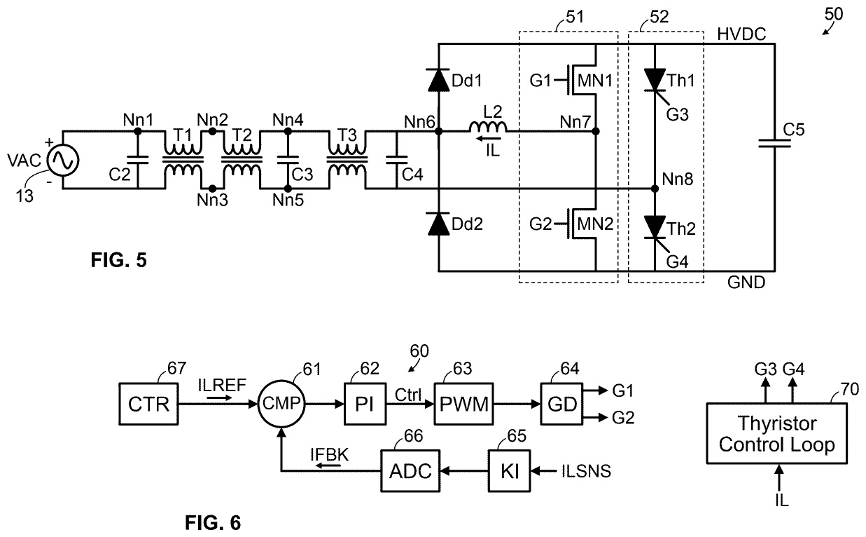

Now described with reference to FIG. 5 is a bidirectional totem pole PFC system 50 including an enhanced approach to commutation assistance. The totem pole PFC system 50 includes a high frequency branch 51 and low frequency branch 52 connected between node HVDC and ground. The high frequency branch 51 is formed by an n-channel transistor MN1 having its drain connected to node HVDC, its source connected to node Nn7, and its gate coupled to be controlled by a gate drive signal G1, and an n-channel transistor MN2 having its drain connected to node Nn7, its source connected to ground, and its gate coupled to be controlled by gate drive signal G2. The low frequency branch 52 is formed by a first thyristor Th1 having its anode connected to node HVDC, its cathode connected to node Nn8, and its cathode gate coupled to be controlled by gate drive signal G3, and a second thyristor Th2 having its anode connected to node Nn8, its cathode connected to ground, and its cathode gate coupled to be controlled by gate drive signal G4. A capacitor C5 is connected between node HVDC and ground. Although the thyristors are illustrated as cathode-gated devices, it will be understood that anode-gated thyristors could instead be used.

An inductor L2 is connected between notes Nn7 and Nn6. A bypass diode Dd1 has its cathode connected to node HVDC and its anode connected to node Nn6, while a bypass diode Dd2 has its cathode connected to node Nn6 and its anode connected to ground.

An AC source 13 has its positive terminal connected to node Nn1 and its negative terminal connected to a second terminal of a capacitor C2. The second terminal of the resistor R2 and the first terminal of the capacitor C2 are connected to node Nn1. A common mode inductor T1 has its primary winding connected between nodes Nn1 and Nn2 and has its secondary winding connected between the negative terminal of the AC source 13 and node Nn3. A common mode inductor T2 has its primary winding connected between nodes Nn2 and Nn4 and its secondary winding connected between nodes Nn3 and Nn5. A capacitor C3 is connected between nodes Nn4 and Nn5. A common mode inductor T3 has its primary winding connected between nodes Nn4 and Nn6 and its secondary winding connected between nodes Nn5 and Nn8. A capacitor C4 is connected between nodes Nn6 and Nn8.

The common mode inductor T1, T2, and T3 and the capacitors C2, C3, and C4 serve various functions within the bidirectional totem pole PFC system 50, such as filtration, noise protection, and smoothing of voltage waveforms across the thyristors Th1 and Th2.

Recall the potential issue of the current through the thyristor Th1/Th2 failing to fall below the holding current before the switching of the AC voltage waveform. In order to address this, two approaches can be considered: modifying the AC current waveform or modifying the AC voltage waveform. Both methods involve making adjustments in the control of transistors MN1 and MN2.

First, the modification of the AC current waveform will be discussed in the context of which the system 50 is operating in inverter mode and providing power to the grid. In the embodiment illustrated in FIG. 6, the first control loop 60 generates the gate drive signals G1 and G2 to control the transistors MN1 and MN2, and a second control loop 70 generates the gate drive signals G3 and G4 for the thyristors Th1 and Th2.

The first control loop 60 includes a current comparator 61, which receives as input a reference current ILREF (a digital value representing the desired AC current level, generated by a controller 67 based upon a stored table) and a feedback current IFBK (a digital value representing the actual inductor current IL). The output of the current comparator 61 is provided to a fast proportional-integral (PI) controller 62. The PI controller 62 adjusts the control signal Ctrl it outputs based on the output of the current comparator 61, i.e., based on the error between the reference current ILREF and the feedback current IFBK. The PI controller 62 quickly responds to changes in the actual inductor current IL, which is used to generate the feedback current IFBK. The control signal Ctrl is received by a pulse width modulation (PWM) generator 63, which generates appropriate switching signals for the transistors MN1 and MN2. These switching signals are received by a gate driver 64 for the transistors MN1 and MN2, which drives the transistors MN1 and MN2 accordingly. To close the loop, the inductor current IL is received through a current scaling block (KI) 65, which senses and scales the inductor current IL (ILSNS being the sensed current) by a scaling factor K. The scaled inductor current is then digitized by an analog-to-digital converter (ADC) 66 to produce the feedback current IFBK.

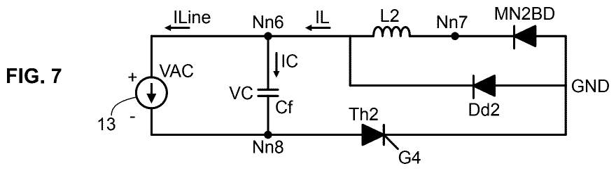

Generation of the table stored in the controller 67 and used to generate the reference current ILREF is now described. Refer to the model of the bidirectional totem pole PFC system 50 shown in FIG. 7. This model represents the current path that would occur when the transistors MN1 and MN2 are turned off before the zero crossing of the AC waveform. Note that the diode labeled MN2BD represents the body diode of transistor MN2, and that the AC source 13 here is represented as a current source. Current IL represents the current through the inductor L2, current IC represents the current into the filtering capacitors C2, C3 and C4 (collectively labeled as capacitor Cf in FIG. 7), and current ILine represents the current returning to the AC source 13.

Keeping this in mind, the voltage ν_{C}, the voltage across filtering capacitors C2, C3 and C4, can be calculated as:

$${v}_{C} ( t ) = λ cos \frac{t}{\sqrt{LC}} + μ sin \frac{t}{\sqrt{LC}} + \frac{{I}_{LINE ( RMS )} \sqrt{2} \cdot ω}{C {ω}^{2} - \frac{1}{L}} cos ( ω t )$$

where: L is the inductance of the inductor L2, C is the capacitance of the filtering capacitor C2, C3 and C4, t_{OFF} is the time between the turn off of the transistors MN1 and MN2 and the zero crossing of the AC waveform, and the values of λ and μ are calculated from initial conditions.

The current i_{L} through the inductor L2 can be calculated as:

$${i}_{L} ( t ) = {I}_{LINE ( RMS )} \sqrt{2} sin ( ω t ) - \frac{C \cdot λ}{\sqrt{LC}} sin ( \frac{t}{\sqrt{LC}} ) + \frac{C \cdot μ}{\sqrt{LC}} cos ( \frac{t}{\sqrt{LC}} ) - \frac{C \cdot {I}_{LINE ( RMS )} \sqrt{2} \cdot {ω}^{2}}{C {ω}^{2} - \frac{1}{L}} sin ( ω t )$$

The value μ can be calculated as:

$$μ = \frac{1}{\frac{{sin}^{2} ( \frac{{t}_{OFF}}{\sqrt{LC}} )}{\sqrt{LC} cos ( \frac{{t}_{OFF}}{\sqrt{LC}} )} + \frac{cos ( \frac{{t}_{OFF}}{\sqrt{LC}} )}{\sqrt{LC}}} \cdot [ \text{} - \frac{sin ( \frac{{t}_{OFF}}{\sqrt{LC}} ) {I}_{LINE ( RMS )} \sqrt{2 \cdot } ω}{\sqrt{LC} cos ( \frac{{t}_{OFF}}{\sqrt{LC}} ) ( C {ω}^{2} - \frac{1}{L}} cos ( ω {t}_{OFF} ) + \frac{sin ( \frac{{t}_{OFF}}{\sqrt{LC}} ) {V}_{AC ( RMS )} \sqrt{2}}{\sqrt{LC} cos ( \frac{{t}_{OFF}}{\sqrt{LC}} )} sin ( ω {t}_{OFF} ) + \frac{{I}_{LINE ( RMS )} \sqrt{2} {ω}^{2}}{C {ω}^{2} - \frac{1}{L}} sin ( ω {t}_{OFF} ) + {V}_{AC ( RMS )} \sqrt{2} \cdot ω cos ( ω {t}_{OFF} ) ]$$

The value λ can be calculated as:

$$λ = \frac{1}{cos ( \frac{{t}_{OFF}}{\sqrt{LC}} )} \cdot [ - μ sin \frac{{t}_{OFF}}{\sqrt{LC}} - \frac{{I}_{LINE ( RMS )} \sqrt{2} \cdot ω}{C {ω}^{2} - \frac{1}{L}} cos ( ω {t}_{OFF} ) + {V}_{AC ( RM S )} \sqrt{2} sin ( ω {t}_{OFF} ) ]$$

Using the equations derived for ν_{C}(t) and i_{L}(t), as well as the calculated values of λ and μ, the controller 67 can determine the appropriate reference current waveform shape to avoid the issue of the current through Th2 failing to fall below its holding current before the zero crossing of the AC waveform. By adjusting the gate drive signals G1 and G2 for the transistors MN1 and MN2 based on the analysis of the mathematical model and determination of the values of λ and μ, the controller 67 can control the AC current waveform such that the current experiences an accelerated decrease towards the end of the half-cycle and maintains a zero current level for a small duration, known as the dead time.

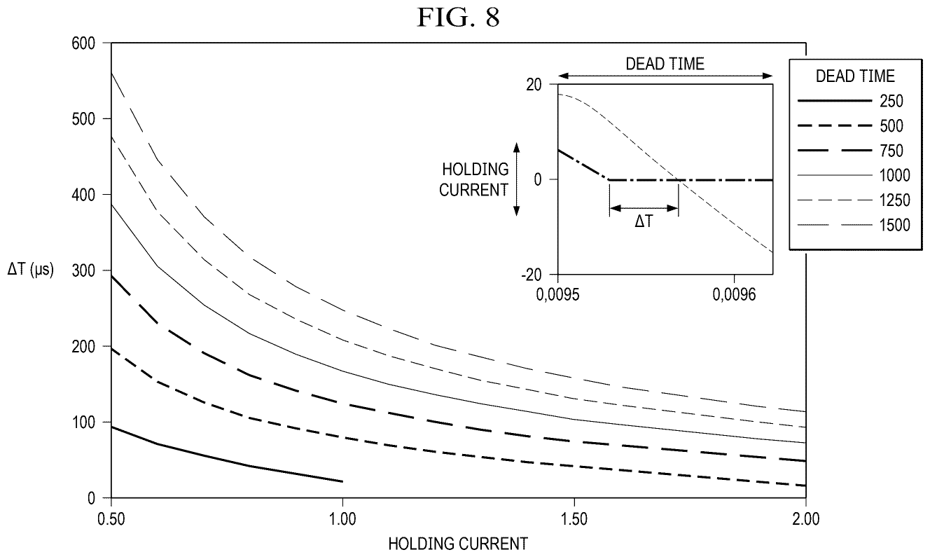

The controller 67 creates a table containing the reference current values that correspond to the desired current waveform shape, taking into account a chosen safety margin ΔT. The safety margin ΔT is the time between the AC current hitting zero and the AC voltage hitting zero, and it is determined based on the desired dead time and the holding current of the thyristor Th2. A greater safety margin provides more time for the current through Th2 to fall below its holding current, providing for a more reliable turn-off, while a smaller safety margin allows for a faster transition to the negative portion of the AC voltage waveform, potentially improving overall efficiency. The effect of dead time and holding current on the safety margin ΔT can be observed in FIG. 8—observe that the safety margin ΔT decreases as the current increases for example.

Therefore, the safety margin ΔT is appropriately chosen to provide for reliable operation while helping to minimize total harmonic distortion (THD) so that the system can achieve stable and efficient performance with low impact on power quality. The safety margin ΔT is therefore chosen to be as small as possible while still providing a sufficient buffer (to account for transients, non-ideality in the transistors, etc.) for the current through Th2 to fall below its holding current before the negative portion of the AC voltage waveform.

Once the table is generated, it is stored within the controller 67. The controller then uses this table to generate the reference current ILREF during the operation of the bidirectional totem pole PFC system 50. The reference current ILREF is input to the current comparator 61, where it is compared with the feedback current IFBK, and the error between them is used by the fast proportional-integral (PI) controller 62 to adjust the control signal Ctrl. This control signal is then used by the PWM generator 63 to produce appropriate switching signals for the transistors MN1 and MN2, allowing the system to achieve the desired current waveform shape with the adjusted safety margin ΔT.

By implementing this technique, the bidirectional totem pole PFC system 50 can effectively control the AC current waveform to help ensure that Th2 turns off before the negative portion of the AC waveform, providing for efficient and stable operation of the system.

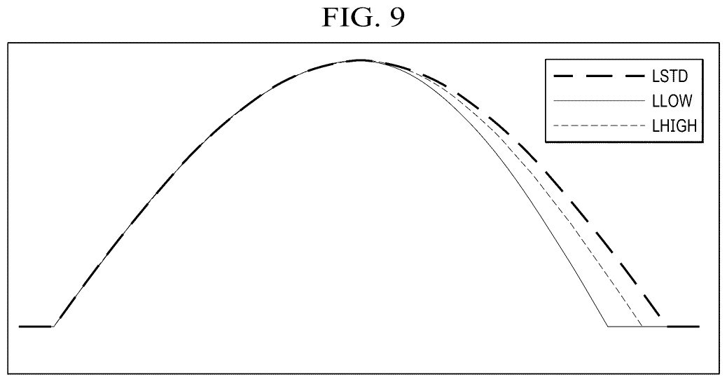

In some embodiments, multiple such tables may be stored within the controller 67. For example, a first table suitable for generating a reference current Ilow suitable for use in a low voltage application (e.g., a grid voltage of 110 V) and a second table suitable for generating a reference current Ihigh suitable for use in a high voltage application (e.g., a grid voltage of 220 V), as shown in FIG. 9. Both of these are shown as compared to a conventional reference current Istd in which the period of the AC waveform does not experience an accelerated decrease towards the end of the positive and negative half-cycle.

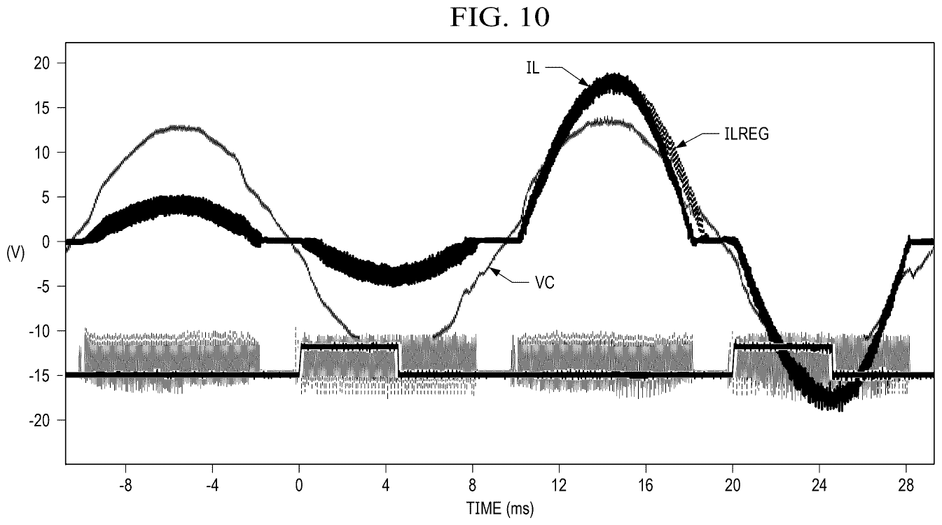

The inductor current IL generated using this current control technique as compared to a conventionally generated inductor current ILREG and the capacitor voltage VC can be observed in FIG. 10. Note that while the currents IL and ILREG have the same waveform shape up until the peak current, after that peak is reached, current IL experiences an accelerated decrease towards the end of the half-cycle.

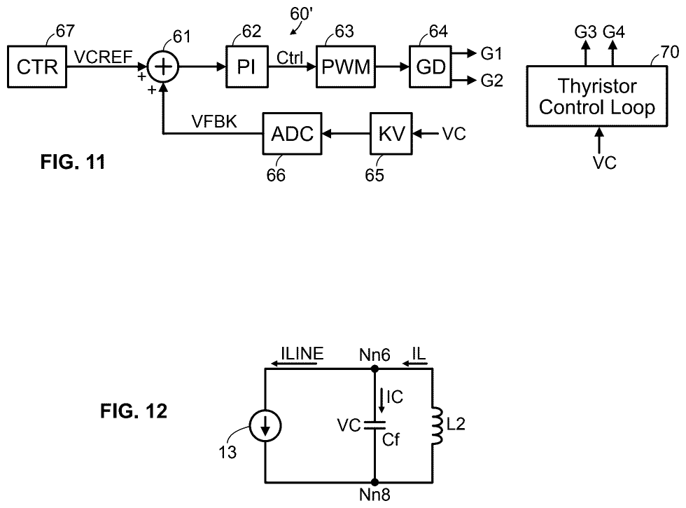

Now described with reference to FIG. 11 is an embodiment of the system 50′ in which regulation of the feedback loop for the transistors MN1 and MN2 is performed based on voltage when the system 50′ is operating in inverter mode and powering a load. In this case, the controller 67 generates a reference voltage waveform, VCREF, instead of a reference current waveform. The voltage control loop 60′ compares the actual voltage VC across filtering capacitors C2, C3 and C4 to the reference voltage waveform, VCREF, and generates appropriate control signals to adjust the gate drive signals G1 and G2 for the transistors MN1 and MN2. By doing so, the controller 67 helps ensure that the desired voltage waveform is maintained across filtering capacitors C2, C3 and C4, which in turn influences the current waveform, helping to avoid the issue of the current through Th2 failing to fall below its holding current before the zero crossing of the AC waveform.

The underlying principle of controlling the current decay and incorporating a safety margin is similar to the previous embodiment. The main difference is that the control loop focuses on regulating the voltage across filtering capacitors C2, C3 and C4 instead of the current through inductor L2—rather than modifying the current IL to ensure that it reaches the holding current prior to the negative half of the voltage waveform, the voltage VC is modified to ensure that the negative half of the voltage waveform does not occur prior to the current IL reaching the holding current. This control loop 60′ is shown in FIG. 11.

In this case, the controller 67 generates a reference voltage waveform VCREF instead of a reference current waveform. The control loop 60′ compares the actual voltage VC across the capacitors to the reference voltage VCREF waveform and generates appropriate control signals to adjust the gate drive signals G1 and G2 for the transistors MN1 and MN2. By doing so, the controller 67 helps ensure that the desired voltage waveform is maintained across the filtering capacitors C2, C3 and C4, which helps avoid the issue of the current IL through Th2 failing to fall below its holding current before the zero crossing of the AC voltage waveform VC by virtue of extending the voltage waveform.

A circuit model representing the system 50 at the end of each half voltage sine wave when the transistors MN1 and MN2 are switched off is shown in FIG. 12; this model focuses on the filtering capacitors C2, C3 and C4 (collectively represented as Cf) and inductor L2. Here, an assist voltage V_{ASSIST} (e.g., voltage plateau) to be applied to the AC voltage waveform shortly prior to the switch-off of the transistors MN1 and MN2 at the end of each half voltage sine wave to thereby extend the period of that half voltage sine wave (so that the negative half wave does not begin until the current has fallen below the holding current) may be calculated as:

$${V}_{ASSIST} > \frac{{i}_{AC} ( {t}_{ASSIST} ) \cdot {e}^{\frac{- a \cdot ω}{b} \cdot ( \frac{T}{2} - {t}_{ASSIST} - DEADTIME )}}{\sqrt{\frac{C}{L}} \cdot sin ( \frac{DEADTIME}{\sqrt{LC}} ) + \frac{1}{a} \cdot {e}^{\frac{- a \cdot ω}{b} \cdot ( \frac{T}{2} - {t}_{ASSIST} - DEADTIME )} - \frac{1}{a}}$$

where L is the inductance of the inductor L2, C is the capacitance of filtering capacitors C2, C3 and C4, t_{ASSIST} is the time between the start of the half voltage sine wave and the application of the assist voltage V_{ASSIST}.

The value a can be calculated as:

$$a = \frac{{V}_{AC ( RMS )}}{{I}_{PEAK}} \cdot \frac{\sqrt{2}}{\sqrt{1 + a {tan}^{2} φ}}$$

The value b can be calculated as:

$$b = \frac{{V}_{AC ( RMS )}}{{I}_{PEAK}} \cdot \frac{\sqrt{2} \cdot a tan φ}{\sqrt{1 + a {tan}^{2} φ}}$$

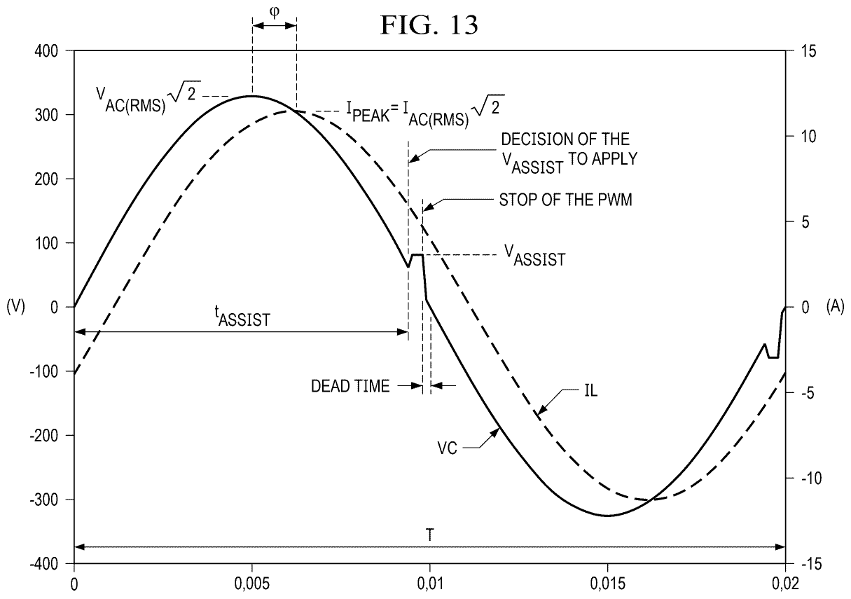

This assist voltage V_{ASSIST} can be observed in FIG. 13.

It is evident that modifications and variations can be made to what has been described and illustrated herein without departing from the scope of this disclosure.

Although this disclosure has been described with a limited number of embodiments, those skilled in the art, having the benefit of this disclosure, can envision other embodiments that do not deviate from the disclosed scope. Furthermore, skilled persons can envision embodiments that represent various combinations of the embodiments disclosed herein made in various ways.

1. A bidirectional power factor correction system, comprising:
a high-frequency branch comprising: a first transistor connected between an IO node and a high-frequency tap, and a second transistor connected between the high-frequency tap and a reference node;
a low-frequency branch comprising: a first thyristor connected between the IO node and a low-frequency tap, and a second thyristor connected between the low-frequency tap and the reference node;
an inductor connected between a first node and the high-frequency tap;
a first capacitor connected between the first node and the low-frequency tap;
wherein the first node and the low-frequency tap are coupled to input terminals; and
a control circuit configured to generate first and second gate drive signals for the first and second transistors so as to accelerate a decrease of an AC current waveform at the input terminals after a peak of a half-cycle of the AC current waveform so that the AC current waveform falls below a holding current of the second thyristor prior to a zero crossing of an AC voltage waveform at the input terminals.

2. The bidirectional power factor correction system of claim 1, wherein the control circuit is configured to accelerate the decrease of the AC current waveform after the peak of the half-cycle of the AC current waveform by comparing a digital reference current to a digital feedback current and generating the first and second gate drive signals based thereupon so that the digital feedback current matches the digital reference current, the digital feedback current being based upon the AC current waveform.

3. The bidirectional power factor correction system of claim 2, wherein the control circuit comprises:
a controller configured to generate the digital reference current based upon stored data;
a current comparator configured to generate a comparison signal based upon comparing the digital reference current to the digital feedback current;
a fast proportional-integral controller configured to generate a PWM control signal based upon the comparison signal;
a pulse width modulation (PWM) circuit configured to generate gate pre-drive signals based upon the PWM control signal;
a gate driving circuit configured to generate the first and second gate drive signals based upon the gate pre-drive signals;
a scaling circuit configured to scale the AC current waveform to produce a scaled waveform; and
an analog to digital converter configured to digitize the scaled waveform to produce the digital feedback current.

4. The bidirectional power factor correction system of claim 3, wherein the stored data comprises multiple tables, including a first table for low voltage applications and a second table for high voltage applications.

5. The bidirectional power factor correction system of claim 3, wherein the controller is configured to generate the digital reference current based on mathematical models that calculate values λ and μ from initial circuit conditions.

6. The bidirectional power factor correction system of claim 1, wherein the control circuit is further configured to generate third and fourth gate drive signals for the first and second thyristors.

7. The bidirectional power factor correction system of claim 1, wherein the control circuit is configured to determine the accelerated decrease based on a safety margin ΔT representing a time between when the AC current waveform falls below the holding current and when the AC voltage waveform reaches zero crossing.

8. The bidirectional power factor correction system of claim 7, wherein the safety margin ΔT is selected to minimize total harmonic distortion while providing sufficient buffer time for reliable thyristor turn-off.

9. The bidirectional power factor correction system of claim 1, further comprising:
common mode inductors connected in series between the first node and the high-frequency tap; and
filtering capacitors connected between respective nodes of the common mode inductors.

10. The bidirectional power factor correction system of claim 1, further comprising bypass diodes connected in parallel with the high-frequency branch and low-frequency branch respectively.

11. The bidirectional power factor correction system of claim 1, wherein the bidirectional power factor correction system is operable in both power factor correction mode and inverter mode.

12. The bidirectional power factor correction system of claim 1, wherein the first and second transistors comprise n-channel MOSFETs and the first and second thyristors comprise cathode-gated thyristors.

13. The bidirectional power factor correction system of claim 1, wherein the control circuit is configured to cease switching of the first and second transistors during a dead time period to allow current through the second thyristor to fall below the holding current.

14. A bidirectional power factor correction system, comprising:
a high-frequency branch comprising: a first transistor connected between an IO node and a high-frequency tap, and a second transistor connected between the high-frequency tap and a reference node;
a low-frequency branch comprising: a first thyristor connected between the IO node and a low-frequency tap, and a second thyristor connected between the low-frequency tap and the reference node;
an inductor connected between a first node and the high-frequency tap;
a first capacitor connected between the first node and the low-frequency tap;
wherein the first node and the low-frequency tap are coupled to input terminals; and
a control circuit configured to generate first and second gate drive signals for the first and second transistors of the high-frequency branch so as to modify an AC signal at the input terminals such that an AC current of the AC signal falls below a holding current of the second thyristor prior to a zero crossing of an AC voltage of the AC signal at the input terminals.

15. The bidirectional power factor correction system of claim 14, wherein the control circuit modifies the AC signal by generating the first and second gate drive signals so as to change the AC signal at the input terminals after a peak of a half-cycle thereof.

16. The bidirectional power factor correction system of claim 15, wherein the control circuit modifies the AC signal based upon a comparison between a digital reference and a digital feedback based upon the AC signal.

17. The bidirectional power factor correction system of claim 16, wherein the digital reference is a digital reference current and the digital feedback is a digital feedback current.

18. The bidirectional power factor correction system of claim 14, wherein the control circuit is configured to create a plateau in the AC voltage for a given period of time after a peak of a half-cycle of the AC voltage.

19. The bidirectional power factor correction system of claim 18, wherein the control circuit creates the plateau by generating the first and second gate drive signals to cause the first and second transistors to apply an assist voltage to the AC voltage during the given period of time.

20. A method of controlling commutation in a bidirectional power factor correction system having a high-frequency branch with first and second transistors and a low-frequency branch with first and second thyristors, the method comprising:
detecting a peak of a half-cycle of an AC signal at input terminals; and
after detecting the peak, modifying a waveform characteristic of the AC signal by controlling switching of the first and second transistors such that an AC current of the AC signal falls below a holding current of the second thyristor prior to a zero crossing of an AC voltage of the AC signal, thereby preventing unintended current flow through the second thyristor during the zero crossing.

21. The method of claim 20, wherein modifying the waveform characteristic comprises accelerating a decrease of the AC current after the peak by generating gate drive signals for the first and second transistors based on a comparison between a digital reference current and a digital feedback current derived from the AC current.

22. The method of claim 21, wherein the digital reference current is generated from stored data comprising multiple lookup tables, each table corresponding to different operating conditions of the bidirectional power factor correction system.

23. The method of claim 20, wherein modifying the waveform characteristic comprises creating a plateau in the AC voltage for a predetermined time period after the peak by applying an assist voltage to the AC voltage through controlled switching of the first and second transistors.

24. The method of claim 23, wherein the assist voltage is calculated based on circuit parameters including inductance, capacitance, and a time duration for maintaining the plateau, such that the AC voltage does not zero cross until the AC current falls below the holding current.

25. The method of claim 20, further comprising:
determining a safety margin ΔT representing a desired time between when the AC current falls below the holding current and when the AC voltage reaches zero crossing; and
controlling the modification of the waveform characteristic based on the determined safety margin to minimize total harmonic distortion while ensuring reliable thyristor turn-off.
